(19) United States
(12) Patent Application Publication
(10) Pub. No.: US 2020/0410468 A1
(43) Pub. Date: Dec. 31, 2020

(54) PROGRAMED LOGIC CONTROLLED VENDING UNIT FOR THE DISTRIBUTION OF FLAME OR HEAT FROM A COMBUSTABILE FUEL SOURCE

(71) Applicant: E-5 LLC, Naches, WA (US)

(72) Inventors: Shayne E. Downing, Naches, WA (US); Elliot M. Baker, Naches, WA (US)

(21) Appl. No.: 16/742,802

(22) Filed: Jan. 14, 2020

Related U.S. Application Data
(60) Provisional application No. 62/867,733, filed on Jun. 27, 2019.

(51) Int. Cl. G06Q 20/12; G06Q 20/18; G06Q 50/06; G06Q 20/40; G07F 15/10; G07F 15/12; G06F 1/3234; G05B 19/416

(52) U.S. Cl. CPC G06Q 20/127; G06Q 20/18; G06Q 50/06; G06Q 20/40; G05B 2219/45006; G07F 15/12; G06F 1/3234; G05B 19/416; G07F 15/10

(57) ABSTRACT

A vending system consisting of a proprietary Programmable Control Board (PCB), which controls an electrically actuated solenoid valve, igniter, timing unit, flame sensor, main burner, and audible alarm. The PCB interfaces with ancillary cash or cashless vending for the system with associated telemetry, as needed, with Customers or users initiating heat and/or flame distribution through user inputs. Upon successful funding, the PCB initiates an ignition sequence, timed flow, audible alert, and user input through a Human-Machine Interface (HMI), and the telemetry of data, followed by a shutdown sequence. Clean burning fuels such as propane, natural gas, butane and other combustible fuels can be utilized to provide flame and or heat for patio heaters, barbecue grills, camp fire pits in public settings such as parks, restaurants, camp grounds, or other areas where patrons may wish to procure propane flame and heat for cooking, ambiance, and warmth.

### TECHNICAL FIELD

A method and apparatus that enable a user to procure the benefits of a clean burning fuel source, including propane, natural gas, butane, or any other gaseous or liquid combustible, specifically through programmed electronic controls for the purpose of creating a flame to provide heat, cooking flame, or ambiance fire.

### BACKGROUND OF THE INVENTION

Fire and heat are a long time staple of human existence. People are drawn to the social bond and essential service that fire and the warmth it provides. Increasingly, restaurants, recreational institutions and properties, and similar establishments have added the provision of fire and heat to their patrons. Conventionally, the flame and/or heating elements are provided at the expense of the owner or proprietor of the establishment, or are brought with and operated by the individual utilizing the facility.

Recreational campfire apparatus traditionally require wood, fuel, and an ignition source to be mobilized to a site. This creates logistical issues, as well as a potential for invasive pests harbored in the wood fuel, excessive smoke and pollutants, and the threat of an inadvertent spread of fire.

Recreational facilities maintained by public and private entities usually provide the traditional fire pits for the discretionary use of patrons, but would be interested in a safer and revenue generating alternative. Propane fire pits recently have become popular, especially at restaurants and residences. Fuel is supplied to these liquid propane fire pits or heaters by a direct connection to a stationary propane tank or with a smaller, portable tank. Similarly, barbeque grills require fuel by a transport of charcoal, lighter fluid, and an ignition source by the intended user, or liquid fueled propane grills fueled at the inconvenience and expense of the facility manager or home owner. Additionally, heat sources for use during colder climate conditions are beginning to be utilized by recreational facilities, such as ski resorts, and restaurants or bars with outdoor or patio seating, as well as in hotel fireplaces. The task of providing a source of flame or heat has fallen on the proprietor of the establishment.

The importance of providing a safe, efficient, reliable source of heat or flame is understood, and there is a need to offset the cost of safely providing these value-added cooking and heating services by the user or consumer.

### SUMMARY OF THE INVENTION

It is therefore an object of the present invention to provide a method and apparatus for providing a flame or heat source by way of electronic commerce. It is another object of the present invention to provide a system and apparatus capable of being configured to provide multi-faceted distribution of flame and heat. It is also an object of the present invention to provide electronic, “e-commerce” (E-Com) based vending of additional fuel sources such as natural gas, butane, and other combustibles. It is further an object of the present invention to provide a user-friendly “Human Machine Interface” (HMI) experience.

It is another object of the present invention to provide a clean burning alternative to wood and charcoal fuel.

It is also another object of the present invention to provide a convenient source of flame and heat to end users.

It is further an object of the present invention to provide e-commerce transaction data to the end user.

It is yet further an object of the present invention to provide fuel use data and system analytics to the service supplier.

It is still another object of the present invention to provide a source of income for the service provider.

These and other objects are achieved by providing an e-commerce activated, electrically controlled supply of fuel for the purpose of providing flame and/or heat through a selection of multi-fuel source operated devices. The apparatus of the invention may be powered by 120v AC supply, or from a DC power source conventionally provided by batteries, and charged by a generator or a solar source. When the combustible fuel is propane, the supply of propane can be from a standard 201b tank, as typically used within conventional patio heater units, or a larger, remotely located, ground mounted tank capable of supplying many units such as fire pits or barbeque grills in a park or campground. Alternatively, natural gas fueled units can be supplied from a centrally located natural gas utility.

The interfaced purchase of a timed supply of fire and/or heat as provide with the present invention accomplishes several objectives. Logistically, the supply of fuel and ignition sources has proved cumbersome, as well as being potentially dangerous. A cash or an E-commerce vending point of purchase system provides a clean, safe, and reliable alternative for the users and surrounding patrons.

Additionally with the present invention, the expense of providing apparatuses and fuel or energy supply no longer falls to the facility proprietor but to the end user and beneficiary of the flame or heat source. A patron interested in the use of flame for heat in the case of a fire pit or patio heater, or cooking in the case of a barbeque grill would be able to utilize a cashless (credit card, tap to pay, E-wallet, IOS or Android App) to purchase a timed supply of heat or flame. Upon payment through the Human Machine Interface (HMI), and preferably following a screen display of safety considerations or precautions instructing the user to safely operate the heat or flame source, and that the apparatus is clear of obstructions, the user selects a time allotment and via Inputs/Outputs (I/O), with an electronically actuated solenoid valve triggered to open the source of fuel and ignite a heat source or flame. With a proprietor adjustable amount of purchased time remaining (20 seconds, for example), the user is notified by an audible signal that the service is coming to an end. At that time, the user has the option to purchase additional service time or the system will initiate shutdown sequences. Telemetry by a hardwired connection, a cell signal, or a satellite link, is utilized to provide payment processing and system condition to the proprietor, as well as user feedback.

The following is a disclosure of the present invention that will be understood by reference to the following detailed description taken in conjunction with the accompanying drawings.

### BRIEF DESCRIPTION OF DRAWINGS

A more complete appreciation of the invention will be readily apparent as the same becomes better understood by reference to the following detailed description when considered in conjunction with the accompanying drawings in which like reference symbols indicate the same or similar components, wherein:

FIG. 1 is a partial schematic flow chart of the operation of a programmed logic controlled vending unit for the distribution of a fuel fired flame or heat source, detailing relationships of its various electrical components, according an embodiment of the present invention;

FIG. 2 is a continuation of the partial flow chart of FIG. 1, of the operation of a programmed logic controlled vending unit for the distribution of a fuel fired flame or heat source, detailing relationships of its various electrical components, according an embodiment of the present invention;

FIG. 3 is a continuation of the partial flow chart of FIGS. 1 and 2, of the operation of a programmed logic controlled vending unit for the distribution of a fuel fired flame or heat source, detailing relationships of its various electrical components, according an embodiment of the present invention;

FIG. 4 is a schematic component diagram of a programmed logic controlled vending unit for the distribution of a fuel fired flame or heat source, according an embodiment of the invention; and

FIG. 5 is a schematic component diagram of a programmed logic controlled vending unit for the distribution of a fuel fired flame or heat source, according to an embodiment of the present invention.

Reference characters included in the above drawings indicate corresponding parts throughout the several views, as discussed herein. The description herein illustrates one or more preferred embodiments of the invention, in one form, and the description herein is not to be construed as limiting the scope of the invention in any manner. It should be understood that the above listed figures are not necessarily to scale and that the embodiments may be illustrated by fragmentary views, graphic symbols, diagrammatic or schematic representations, and section lines. Details not necessary for an understanding of the present invention by one skilled in the technology of the invention, or render other details difficult to perceive, may have been omitted.

### DETAILED DESCRIPTION OF SPECIFIC EMBODIMENTS

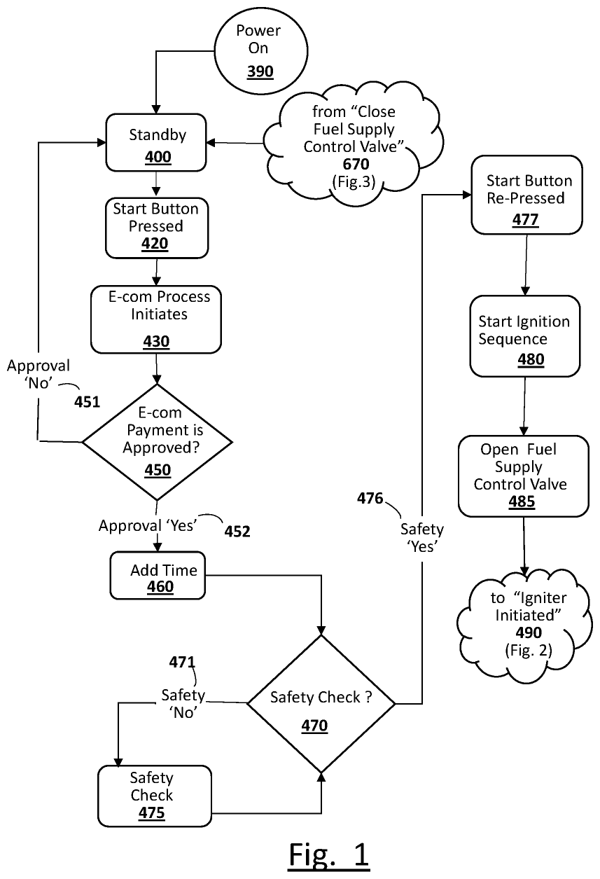

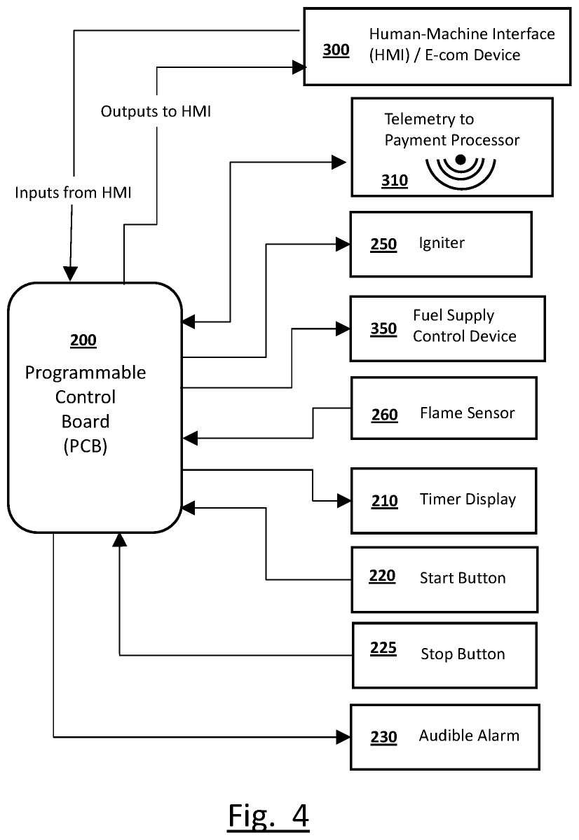

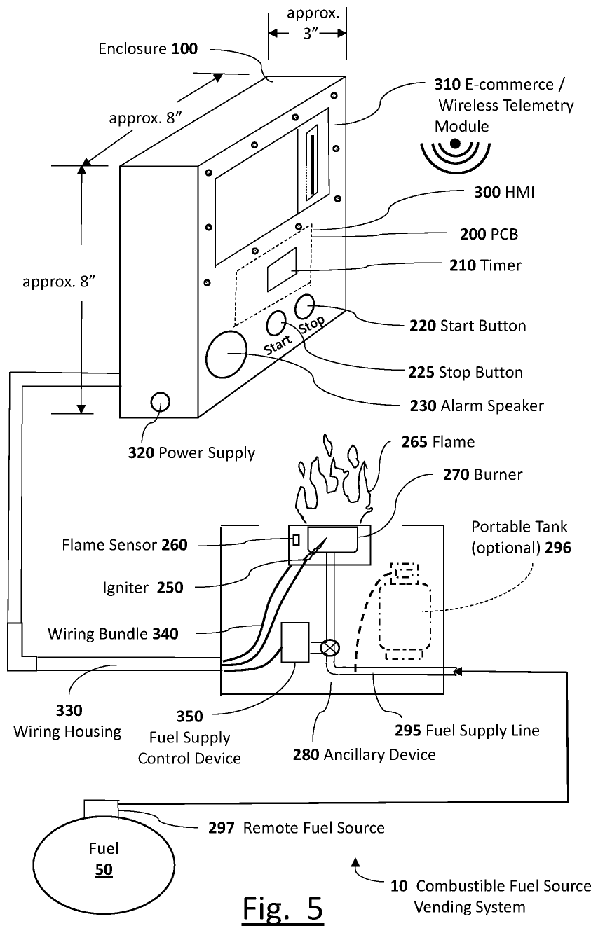

The present invention provides a programmed logic controlled vending unit for the distribution of a flame or heat source, with FIGS. 1 through 5 showing features of preferred embodiments of the apparatus and method having features according to the present invention ad detailed and described herein. Specifically, FIG. 4 shows a proprietary “programmed control board,” which may be referred to herein simply as a PCB 200, and which controls all electronic functions of the system components that are shown in FIG. 5. FIGS. 1 through 3 show a preferred operational sequence of initiating a purchased burn sequence and subsequent additional time purchase or system shutdown sequence for the “programmed logic controlled vending unit for the distribution of a flame or heat from a combustion source,” as shown schematically in FIG. 5 and which is referred to herein as the Combustible Fuel Source Vending System 10, or alternatively more simply as the System, with the combustible fuel source selected from any fuel 50 that is combustible to generate heat or flame, including propane, natural gas, butane, or any other conventional gaseous or liquid combustible fuel.

As detailed in FIG. 5, the Combustible Fuel Source Vending System 10 includes an enclosure 100 that houses the PCB 200, along with a timer 210, a start button 220 and a stop button 225, and an audible alarm 230 which is preferably a speaker optionally coupled with a bright light to signal alarms and operational time expiration. The timer can be referred to herein as a timer display, and is most preferably an organic light emitting diode “OLED,” or alternatively a light emitting diode “LED,” with such display devices as well known to those skilled in timer or clock displays. The enclosure also includes a human-machine interface panel 300, and an e-commerce, wireless telemetry module 310. The “human-machine interface panel” may be referred to herein simply as an HMI, and the “e-commerce/wireless telemetry module” may be referred to herein simply as the e-com module.

A preferred an e-com module 310 includes using an “ePort” hardware supported “data exchange” (DEX) connections to a “virtual machines” (VMS) and a “multi-drop bus” (MDB) interface, conventionally used in bill validation and smartcard reading, with DEX a protocol and interface used for auditing vending types of machines as standardized by the National Automatic Merchandising Association. As known by technicians skilled in such protocols and hardware, DEX is a standard RS232 serial connection with a typical asynchronous “8-n-1” transfer. The preferred MDB requires both special physical connection layer and special handling in code with a byte transfer of 11 bits containing a special “mode bit,” which requires special handling in code. Furthermore, ePort is a “payment card industry” (PCI) security standard, as certified by VISA, MasterCard and American Express brands of credit card services, and employs the “card industry data security standard” (PCI DSS), which is a set of security standards designed to ensure that all companies that accept, process, store, and transmit credit card information maintained a secure environment. Additionally, a preferred over-air interface for the e-com module would be dedicated dual band EVDO, CDMA 1×RTT female DEX, and MDB connections on the PCB 200, as manufactured by Honeywell International Inc. of Morris Plains, N.J., for example. The HMI and the e-com module may also interface with an “e-wallet,” “tap-to-pay,” or any other transactional applications for use with an electronic handheld information device, or personal digital assistant (PDA). These PDA based monetary transaction services, are well known to persons skilled in electronic device based commercial transaction services.

The enclosure 100, as shown schematically in FIG. 5 most preferably is made of a stainless steel, or alternatively a heavy duty and weather resistant plastic material. The enclosure may be mounted remotely to or directly to the rest of the System 10. All devices contained in the enclosure are powered by a power supply 320, preferably routed to an ancillary device 280 by a wire bundle 340, most preferably within a wire housing 330. As shown schematically in FIG. 4, the wire housing encloses and protects the wiring bundle, to connect the PCB and to a fuel supply control device 350, which are contained in the ancillary device 280. The fuel supply control device is most preferably an electrically actuated solenoid valve, but can be any conventional control valve, or metering device, specifically suited to the selected fuel 50. The ancillary device may be any flame or heat producing device that employs a combustion process to generate the flame or heat. For example, the ancillary device may be a fire pit, a BBQ (barbecue) grill or cooking element, a patio heater, a fireplace insert, or any conventional flame or heat producing device in the alternative, as would be selectable by those persons with knowledge of heat and flame producing combustion devices.

Most preferably, the ancillary device 280 contains a burner unit 270, the fuel supply control device 350, an igniter 250, and a flame sensor 260. The fuel 50 is supplied to the auxiliary burn unit housing from a fuel supply line 295. Optionally, as shown in FIG. 5, the fuel supply line may connect to a portable tank 296 housed, preferably located within the ancillary device, such as is conventional for a patio heater. Alternatively, the fuel may be supplied from a larger remote fuel tank, which is referred to herein as a remote fuel source 297, as shown also in FIG. 5. The remote fuel source is a most preferred option for serving any multiple of the Combustible Fuel Source Vending System 10 from a single fuel supply line and again, the fuel may be propane, natural gas, butane, or any other conventional gaseous or liquid combustible fuel.

As shown in FIG. 1, the operation of the Combustible Fuel Source Vending System 10 initiates with a Power On 390, most preferably accomplished by simply connecting the System to a power source by plugging the enclosure into the power supply 320, which may be a standard 120 volt AC, or alternatively a low voltage DC source, as could be supplied by a battery that is charged by a generator or a solar power or other renewable source. After the Power On, the operation of the System enters a Standby 400. The user may then press the start button 220, as shown in FIG. 5, to begin interaction with the System. With the Start Button Pressed 420 the HMI 300 displays the payment options as an E-com Process Initiates 430, which begins the transaction processing procedure for the user.

After the E-com Process Initiates 430 and an input of payment from the user, the Combustible Fuel Source Vending System 10 internally quires if an E-com Payment is Approved? 450, as shown in FIG. 1. Then, the System either rejects payment attempt with an Approval ‘No’ 451, which results in the System re-entering the Standby 400, or an Approval ‘Yes’ 452, which results in an Add Time 460. The Add Time is achieved after the successful payment from the user, confirmed through the e-com module 310, in which the user selects a desired burn time and completes any user inputs required to complete a transaction, as is known to those skilled in electronic monetary transactions.

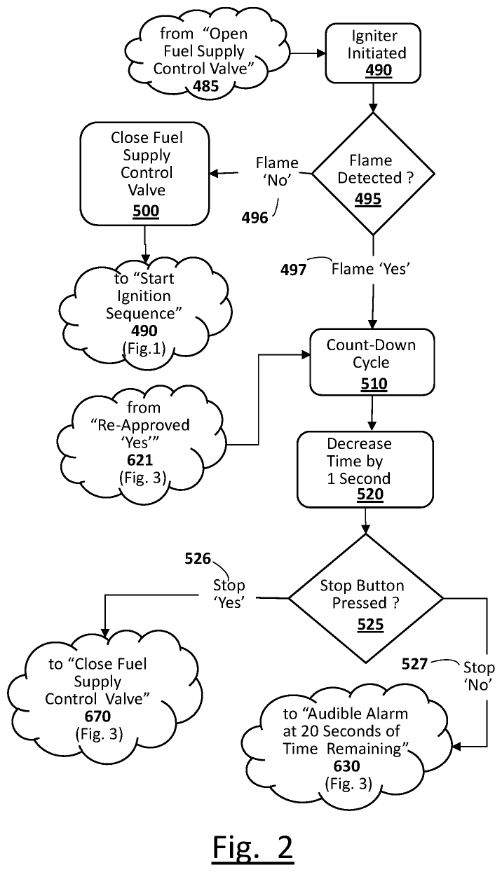

With the Add Time 460 operational step, the PCB 200 displays the user purchased time to the HMI 300, which is most preferably a touch activated LCD 210, which is a display screen or an equivalent interactive display and touchpad, and shown in FIG. 5. This displayed time is the initial time allotted for operation of the burner unit 270, and later reduced in the operation of the System 10 after a Count-Down Cycle 510, as shown in FIG. 2.

An important optional feature of the System 10 is a safety check. After the Add Time 460 function, a Safety Check? 470 request is made by the System 10, for user input. Preferably, the safety check includes a message displayed on the HMI 300, instructing the user or operator of the System to verify that the burner unit 270 is clear of obstructions, and verify that the user accepts responsibility in the safe operation of the System. If the Safety ‘No’ 471 is retuned by the Safety Check request, a Safety Check 475 must be affirmed by the user, and the System may perform any additional automated safety checks as might be appropriate, including internal electrical checks, maintenance checks and verification of proper function of components.

The Safety Check 475 then returns to Safety Check? 470 and the operation of the System 10 then proceeds to Safety ‘Yes’ 476, and the Start Button Re-Pressed 477 to a Start Ignition Sequence 480. The Start Ignition Sequence is followed by an Open Fuel Supply Control Valve 485, which opens the electrically actuated solenoid valve 240, with an Igniter Initialed 490 as shown in FIG. 2, and then the igniter 250 sparks, and triggers the flame detector 260, upon detection of a flame 265. If the flame is not detected by the flame detector at a Flame Detected? 495 function, a Flame ‘No’ 496, is executed and the solenoid valve 240 is electronically closed at a Close Fuel Supply Control Valve 500, by a requisite output signal from the PCB 200, with the start ignition sequence attempting a restart for up to three cycles, as is most preferred.

After the preferred three cycles of attempting the restart, the Combustible Fuel Source Vending System 10 goes into Standby 400 and notifies the proprietor by a system fail telemetry signal 315. If the flame 265 is detected at the Flame Detected? 495 function, a Flame ‘Yes’ 497 occurs, and the PCB 200 initiates a Countdown Cycle 510, as displayed on the timer 210 preferably decreasing in one second intervals, while the fuel 290 is supplied to and burned in the burner unit 270.

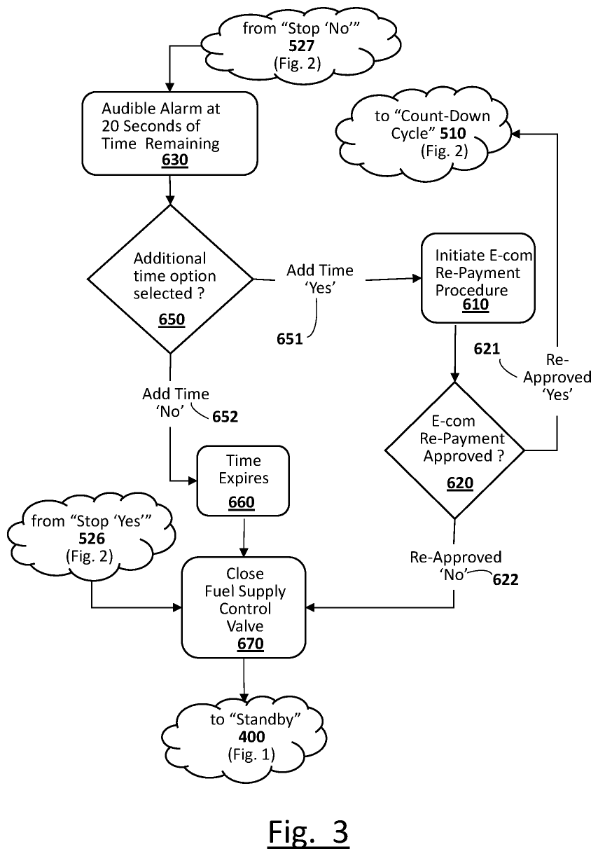

Unless the stop button 225 is pushed by the user during the burner operation Count-Down Cycle 510 of the System 10, the PCB 200 will continue with a Decrease Time by 1 Second 520 instruction as shown in FIG. 2, which decreases the time until the solenoid valve 240 is closed and the fuel 290 no longer is supplied to the burner unit 270. Preferably, the burn time is decreased in one second intervals with an Audible Alarm at 20 Seconds of Time Remaining 630 executed as shown in FIG. 3, most preferably with a triggering of an audible alarm from the audible alarm 230, and preferably also displayed visually on the HMI 300, with an allotted time remaining of preferably 20 seconds, in the burner operational Count-Down Cycle. Alternatively, any convenient time remaining period could be selected. Again, this alarm is most preferably audible and visual, and serves to notify the user of time expiration and the approaching of a Close Fuel Valve 670 operational step.

If the user opts to procure more burn time at an Additional Time Option Selected? 650, the user selects an Add Time ‘Yes’ 651, and the additional purchase will occur through the e-com module 310 through an Initiate E-com Re-Payment Procedure 610, as shown in FIG. 3, with user input to the HMI 300. Payment approval through the E-com Re-Payment Approved? 620 process step then to a Re-Approved ‘Yes’ 621 add allotted time displayed to the timer 210 shown in FIGS. 4 and 5, by way of the PCB 200 program. The burner operation Count-Down Cycle 510 will then continue, as shown in FIG. 2. If the E-com Re-Payment Approved? 320 results in an Approved ‘No’ 622, a Close Fuel Valve 670 occurs, and the System 10 enters into the Standby 400.

At the Additional Time Option Selected? 650, at an Add Time ‘No’ 652, the user simply may allow the System to enter a Time Expires 660, as would be displayed on the timer 210, at which time the Close Fuel Supply Control Valve 670 is executed by instruction from the PCB 200, and the gas valve 240 will close and the Combustible Fuel Source Vending System 10 will enter into the Standby 400.

As shown in FIG. 2, if the stop button 225 is pressed at any time during the burner operation, with a Stop ‘Yes’ 526 executing after a Stop button Pressed? 525 function, the. Count-Down Cycle 510, the Close Fuel Valve 670 operation closes the fuel supply control device 350, and the Combustible Fuel Source Vending System 10 enters the Standby 400, until this pause is cleared by user input to the HMI 300, resulting in action of the PCB 200, with the user instructed to press the start button 220, at which time the System will again begin at the start of the ignition sequence 230, and remaining time displayed with the Count-Down Cycle 510, preferably displayed on the timer 210. Without the stop button being pressed, a Stop ‘No’ operation is entered into, and the Audible Alarm at 20 Seconds of Time Remaining 630 is executed or re-executed, as shown in FIG. 3

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. The above described and illustrated invention is not to be limited except by the following claims, as appropriately interpreted in accordance with the doctrine of equivalents. Therefore, the true scope of the invention will be defined by the appended claims.

The following is claimed:

1. A process of a programmed logic controlled vending unit for distribution of a timed supply of a combustible fuel comprising the steps of:
a) displaying a payment option to initiate an e-commerce transaction to receive a payment on a human interface panel;
b) approving the payment to provide a purchased burn time;
c) displaying the purchased burn time on the human interface panel;
d) initiating a time count-down from the purchased burn time;
e) starting an ignition of the a combustible fuel by electronically opening a combustible fuel valve, igniting the combustible fuel in a burner, and triggering a flame detector;
f) burning the combustible fuel in the burner;
g) electronically closing the combustible fuel valve if a flame is not detected by the flame detector;
h) displaying the purchased burn time on the human interface panel while the combustible fuel is burned in the burner, and decreasing the purchased burn time displayed on the human interface panel;
i) triggering an alarm on the human interface panel when the purchased burn time approaches zero; and
j) electronically closing the combustible fuel valve when the purchased burn time equals zero.

2. The process of a programmed logic controlled vending unit for distribution of a timed supply of a combustible fuel of claim 1, additionally comprising the step of:
k) requiring an automated safety check prior to starting an ignition of the a combustible fuel.

5. A process of a combustible fuel source vending system comprising the steps of:
a) initiating a power on mode by connecting the combustible fuel source vending system to a power source;
b) entering a standby mode;
c) beginning a user interaction with the combustible fuel source vending system with a pressing of a start button by the user;
d) initiating an e-commerce process and displaying a payment option to begin a transaction processing procedure for the user;
e) internally querying by the combustible fuel source vending system if a e-commerce payment is approved, after an input of the e-commerce payment from the user;
f) approving the e-commerce payment for adding a user selected burn time;
g) displaying the burn time purchased by the user, with the user selected burn time a burner time period allotted for operation of a burner unit during a count-down cycle;
h) decreasing the burner time period until a zero time remains; and
i) closing a solenoid valve, with a fuel no longer supplied to the burner unit.

6. The process of a combustible fuel source vending system of claim 5, additionally comprising the steps of:
j) rejecting payment attempt; and
k) re-entering the standby mode.

7. The process of a combustible fuel source vending system of claim 5, additionally comprising the step of:
j) triggering an alarm with a time remaining of the burn time in the count-down cycle.

8. The process of a combustible fuel source vending system of claim 5, additionally comprising the steps of:
j) procuring an additional user selected burn time by the user;
k) procuring the additional user selected burn time by the e-commerce process;
l) adding an allotted time displayed to the timer; and
m) continuing the count-down cycle for operating the burner unit.

9. The process of a combustible fuel source vending system of claim 5, additionally comprising the steps of:
j) displaying a time expired on a timer;
k) closing a fuel supply control valve; and
l) re-entering the standby mode.

10. The process of a combustible fuel source vending system of claim 5, additionally comprising the steps of:
j) pressing a stop button by the user during operation of the burner unit during the count-down cycle;
k) entering the standby mode until the user presses a start button; and
l) beginning at the start of the ignition sequence with remaining time of the count-down cycle displayed on the timer.

11. The process of a combustible fuel source vending system of claim 5, additionally comprising the steps of:
j) performing a user input safety check by the combustible fuel source vending system, after a user request from more time is made;
k) displaying a safety check message instructing the user to verify that the burner unit is clear of obstructions, and verify that the user accepts responsibility in the safe operation of the combustible fuel source vending system;
l) performing automated safety checks; and
m) continuing the user interaction with the combustible fuel source vending system with a re-pressing of a start button by the user.

12. The process of a combustible fuel source vending system of claim 5, additionally comprising the steps of:
j) re-entering the standby mode of the combustible fuel source vending system after a failure to complete the start ignition sequence; and
k) notifying a proprietor by a system fail telemetry signal.
